(19) United States
(12) Patent Application Publication
(10) Pub. No.: US 2011/0228751 A1
(43) Pub. Date: Sep. 22, 2011

(54) WIRELESS COMMUNICATION APPARATUS AND SEMICONDUCTOR DEVICE

(75) Inventors: Masahiro Takagi, Tokyo (JP); Kaoru Inoue, Tokyo (JP)

(73) Assignee: KABUSHIKI KAISHA TOSHIBA, Tokyo (JP)

(21) Appl. No.: 13/015,707

(22) Filed: Jan. 28, 2011

(30) Foreign Application Priority Data
Mar. 17, 2010 (JP) 2010-61017

(51) Int. Cl. H04W 84/02

(52) U.S. Cl. 370/338

(57) ABSTRACT

A wireless communication apparatus includes a first wireless communicator, a second wireless communicator, and a controller. The first wireless communicator transmits and receives a wireless signal according to a first communication protocol, and scans a notice signal during a predetermined scan term in a first cycle non-integer times at least one of notice signal cycles in the first communication protocol. The second wireless communicator transmits and receives the wireless signal according to a second communication protocol. The controller switches the second wireless communicator to an non-transmission state and the first wireless communicator to a reception state during the scan term.

### CROSS REFERENCE TO RELATED APPLICATIONS

This application is based upon and claims the benefit of priority from the prior Japanese Patent Application No. 2010-061017, filed on Mar. 17, 2010, the entire contents of which are incorporated herein by reference.

### FIELD

The present invention relates to a wireless communication apparatus and a semiconductor device.

### BACKGROUND

As for mobile devices such as notebook computers in recent years, it is demanded to mount a wireless communication apparatus corresponding to a plurality of communication protocols, for example, Wi-Fi (Wireless Fidelity) such as IEEE 802.11a/b/g/n and WiMAX (World Interoperability for Microwave Access) such as IEEE 802.16-2004 and IEEE 802.16e. In such a wireless communication apparatus, an antenna is often shared by a plurality of communication protocols in order to shrink the mobile device.

However, the frequency bands (2.4 [GHz]) of the Wi-Fi and the frequency band (2.5 [GHz]) of the WiMAX are in close vicinity to each other. This results in a problem that radio waves interfere when a plurality of communication protocols are utilized at the same time.

On the other hand, in the mobile device, a communication protocol such as Wi-Fi or WiMAX is utilized for data communication. Therefore, it is necessary to switch one communication protocol to the other communication protocol without a time lag.

In the conventional wireless communication apparatus, however, it is not possible to switch the communication protocol automatically without a time lag.

### BRIEF DESCRIPTION OF THE DRAWINGS

FIG. 1 is a block diagram illustrating a configuration of a wireless communication apparatus 10 according to an embodiment.

FIG. 2 is a schematic diagram of a time series of a scan of a notice signal of a first communication protocol.

FIG. 3 is a schematic diagram of a residual series of the scan of the notice signal of the first communication protocol.

FIG. 4 is a schematic diagram of switching a reception channel of the first communication protocol.

FIG. 5 is a schematic diagram of a time series of a second communication protocol.

FIG. 6 is a state transition diagram of the first wireless communicator 13 and the second wireless communicator 14.

### DETAILED DESCRIPTION

Embodiments will now be explained with reference to the accompanying drawings.

In general, according to one embodiment, a wireless communication apparatus includes a first wireless communicator, a second wireless communicator, and a controller. The first wireless communicator transmits and receives a wireless signal according to a first communication protocol, and scans a notice signal during a predetermined scan term in a first cycle non-integer times at least one of notice signal cycles in the first communication protocol. The second wireless communicator transmits and receives the wireless signal according to a second communication protocol. The controller switches the second wireless communicator to an non-transmission state and the first wireless communicator to a reception state during the scan term.

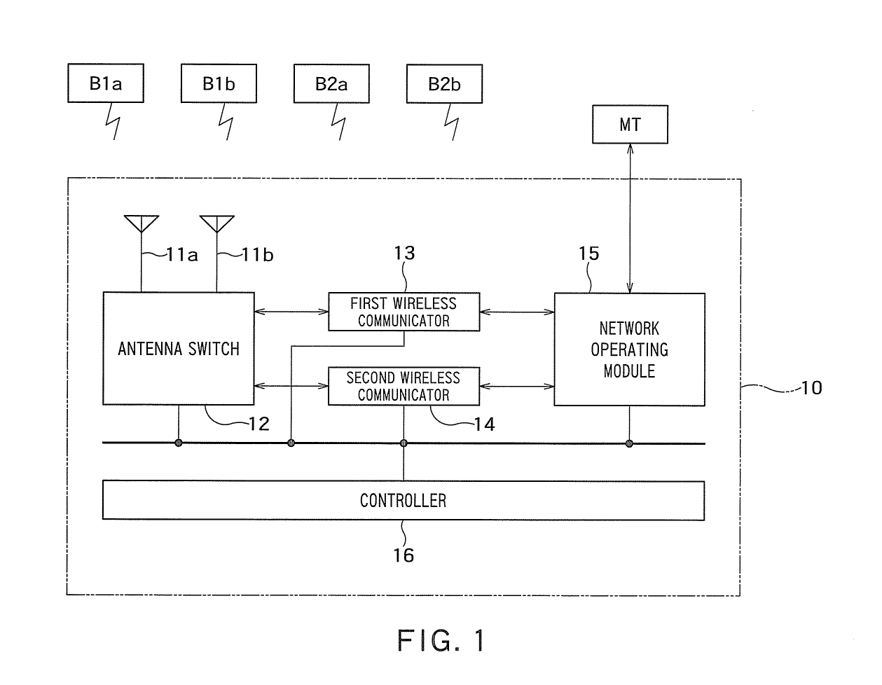

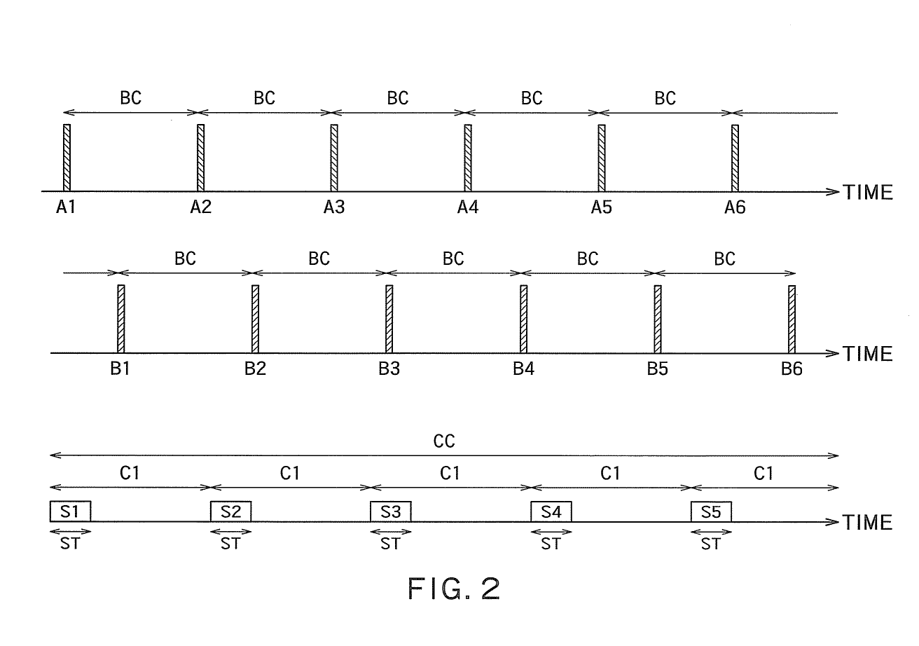

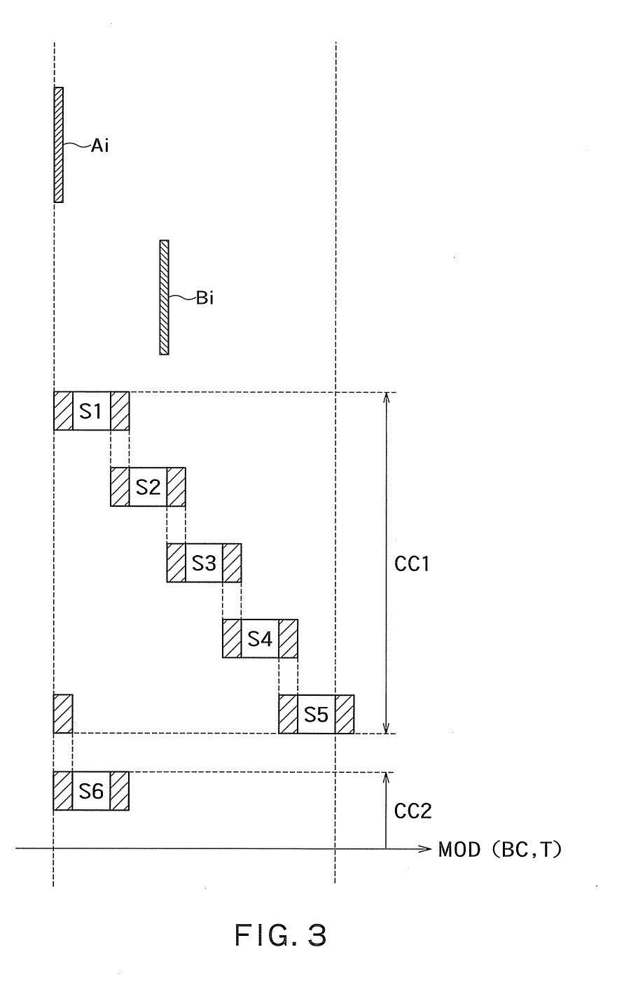

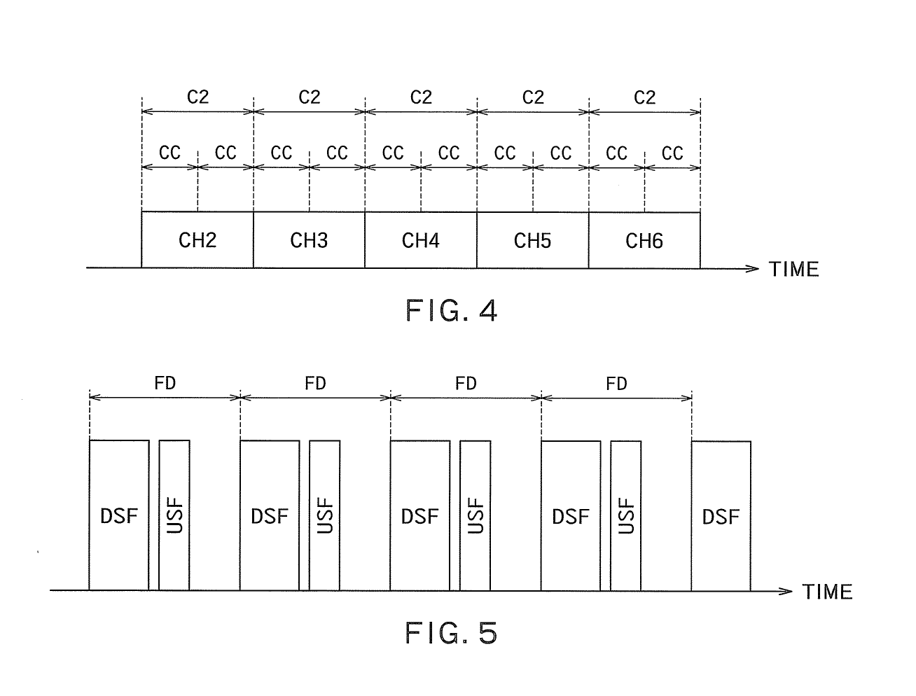

A configuration of a wireless communication apparatus according to an embodiment will now be explained. FIG. 1 is a block diagram illustrating a configuration of a wireless communication apparatus 10 according to an embodiment. FIG. 2 is a schematic diagram of a time series of a scan of a notice signal of a first communication protocol. FIG. 3 is a schematic diagram of a residual series of the scan of the notice signal of the first communication protocol. FIG. 4 is a schematic diagram of switching a reception channel of the first communication protocol. FIG. 5 is a schematic diagram of a time series of a second communication protocol.

As shown in FIG. 1, a wireless communication apparatus 10 includes two antennas 11a and 11b, an antenna switch 12, a first wireless communicator 13, a second wireless communicator 14, a network operating module 15, and a controller 16. At least a portion of the wireless communication apparatus 10 may be composed of a semiconductor integrated circuit.

The first antennas 11a and 11b are configured to transmit and receive wireless signals with first base stations B1a and B1b and second base stations B2a and B2b, respectively. The first base stations B1a and B1b are base stations of the first communication protocol for wireless LAN (Local Area Network) such as Wi-Fi suitable for high speed communication. The second base stations B2a and B2b are base stations of the second communication protocol for TDD (Time Division Duplex) such as WiMAX suitable for wide area communication. Although an example in which the number of antennas is two has been explained in the embodiment, the number of antennas is not limited to this.

The antenna switch 12 of FIG. 1 is configured to switch a path of a wireless signal transmitted and received by the antennas 11a and 11b. As a result, the first wireless communicator 13 and the second wireless communicator 14 can share the antennas 11a and 11b.

The first wireless communicator 13 of FIG. 1 is configured to transmit and receive a wireless signal according to the first communication protocol. Furthermore, the first wireless communicator 13 is configured to scan a notice signal Aᵢ transmitted from the first base station B1a and a notice signal Bᵢ transmitted from the first base station B1b. States of the first wireless communicator 13 include a reception state for receiving wireless signals transmitted from the first base stations B1a and B1b, a transmission state for transmitting a wireless signal to the first base stations B1a and B1b, and an non-connection state for cutting off connection to the first base stations B1a and B1b.

In the first communication protocol, notice signals A₁ and B₁ are transmitted respectively from the first base stations B1a and B1b in a predetermined notice signal cycle BC. Timing of transmission of the notice signal Aᵢ is different from timing of transmission of the notice signal Bᵢ. The first wireless communicator 13 scans the notice signals Aᵢ and Bⱼ transmitted from the first base stations B1a and B1b only during a predetermined scan term ST in a cycle (hereafter referred to as “first cycle”) C1 (scan cycle) which is non-integer times the notice signal cycle BC. If the notice signals Aᵢ and Bᵢ are transmitted during the scan term ST, the notice signals Aᵢ and Bⱼ are detected by the first wireless communicator 13. In FIG. 2, the notice signal A₁ is detected during a first scan S1 and the notice signal B₃ is detected during a third scan S3. The first wireless communicator 13 repeats a plurality of scans (for example, five scans S1 to S5) in a cyclical cycle CC. In the time series, the scan terms ST are arranged intermittently. A sum of respective first cycles C1 corresponding to the scans S1 to S5 is the cyclical cycle CC. The cyclical cycle CC is the least common multiple of the first cycle C1 and the notice signal cycle BC. When the first cycle C1 is a dividend and the notice signal cycle BC is a divisor, the scan term ST is at least a residue (see Equation 1). For example, the notice signal cycle BC is 100 [msec], the first cycle C1 is 120 [msec], the scan term ST is 30 [msec], and the cyclical cycle CC is 600 [msec].

ST≧MOD(C1,BC) (Equation 1)

More typically, the scan term ST may be determined based on Equation 2. For example, in the case where the notice signal cycle BC inherent to the first base stations B1a and B1b is given, the first cycle C1 is determined such that the cyclical cycle CC which is the least common multiple of the notice signal cycle BC and the first cycle C1 is a suitable value. In Equation 2, N is a quotient in the case where the cyclical cycle CC is a dividend and the first cycle C1 is a divisor. As indicated by Equation 2, the scan cycle ST is at least a quotient in the case where the notice signal cycle BC is a dividend and N is a divisor.

$$ST \geq BC / N = BC / ( LCM ( BC , C 1 ) / C 1 ) \qquad ( Equation 2 )$$

The scan term ST is determined based on Equation 2. As appreciated from the ensuing description of FIG. 3, notice signals Aᵢ and Bᵢ of a single channel, which are transmitted from the first base stations B1a and B1b at arbitrary timing, can be detected by N scans during the scan term ST. The time of the cyclical cycle CC is necessary for N scans. The above-described “the cyclical cycle CC is a suitable value” means that a value of the cyclical cycle CC does not cause any problems in practical use. If the cyclical cycle CC is too long, it takes a long time to scan. If the cyclical cycle CC is too short, communication conducted by the second wireless communicator 14 is hampered excessively by the scan conducted by the first wireless communicator 13.

In a residue series in the case where the time T is a dividend and the notice signal cycle BC is a divisor, scan terms ST are arranged to overlap in their parts as shown in FIG. 3. A part where a scan Sₙ and a scan Sₙ₊₁ overlap (that is, a part where two adjacent scan terms overlap) is a latter part of the scan Sₙ (that is, a previous scan) and a former part of the scan Sₙ₊₁ (that is, a latter scan). For example, a part where the scan Sₙ and the scan Sₙ₊₁ overlap has a length of 10 [msec]. For demodulating the notice signals Aᵢ and Bᵢ in at least one of the scan Sₙ and the scan Sₙ₊₁ correctly, it is necessary that the notice signals Aᵢ and Bᵢ are completely included in at least one of scan term ST of the scan Sₙ and the scan Sₙ₊₁. In the present embodiment, therefore, it is preferable to set the length of overlapping parts of scan terms ST longer than the length of the supposed continuation time for which the notice signals Aᵢ and Bᵢ are transmitted.

As described above, Equation 1 holds true about the scan term ST and scan terms ST are arranged to overlap in parts in the residue series in the case where the time T is a dividend and the notice signal cycle BC is a divisor. Even if scans are conducted by the first wireless communicator 13 intermittently, therefore, the notice signals Aᵢ and Bᵢ transmitted from the first base stations B1a and B1b at mutually different timing can be detected without omission.

As shown in FIG. 4, the first wireless communicator 13 switches the reception channels CH2 to CH6 every predetermined second cycle C2 (channel cycle). The second cycle C2 is at least the cyclical cycle CC which is the least common multiple of the notice signal cycle BC and the first cycle C1 (see Equation 3). Even if the transmission channel of the first base stations B1a and B1b is unknown, therefore, the notice signals Aᵢ and Bᵢ can be detected without omission. Incidentally, it is preferable that the second cycle C2 is an integer times the cyclical cycle CC to dispose the scan terms ST in respective channels equally.

$$C 2 \geq CC = LCM ( BC , C 1 ) \qquad ( Equation 3 )$$

In the case where a plurality of different notice signal cycles exist respectively for a plurality of first base stations (for example, a first notice signal cycle of the first base station B1a and a second notice signal cycle of the first base station B1b exist), if the first cycle C1 which is non-integer times at least one of notice signal cycles (for example, the first notice signal cycle) is integer times another notice signal cycle (for example, the second notice signal cycle) and deviates from the notice signal Bᵢ in phase, the notice signal Bᵢ transmitted in the second notice signal cycle which is integer times the first cycle C1 can be detected even if the notice signals Aᵢ and Bᵢ are scanned in the first cycle C1 which is non-integer times the first cycle C1.

In this case, the first wireless communicator 13 of FIG. 1 selectively executes a plurality of scan operations to scan notice signals in respectively different first cycles C1 under a predetermined condition. Therefore, all the notice signals can be detected without omission.

For example, the first wireless communicator 13 switches first scan operation and second scan operation alternately. The first scan operation is one for scanning notice signals Aᵢ and Bⱼ respectively transmitted from the first base stations B1a and B1b in the first cycle C1 which is non-integer times the first notice signal cycle. The second scan operation is one for scanning notice signals Aᵢ and Bⱼ respectively transmitted from the first base stations B1a and B1b in the first cycle C1 which is non-integer times the second notice signal cycle. In the first scan operation, scans are repeated a predetermined number of times in a first cyclical cycle determined based on the first cycle C1, which is non-integer times the first notice signal cycle. In the second scan operation, scans are repeated a predetermined number of times in a second cyclical cycle determined based on the first cycle C1, which is non-integer times the second notice signal cycle. Even if the first cycle C1 is an integer times the second notice signal cycle and deviates from the notice signal Bᵢ in phase, therefore, all the notice signals Aᵢ and Bⱼ can be detected without omission.

The second wireless communicator 14 of FIG. 1 is configured to transmit and receive wireless signals according to the second communication protocol. States of the second wireless communicator 14 include a reception state for receiving wireless signals transmitted from the second base stations B2a and B2b, a transmission state for transmitting wireless signals to the second base stations B2a and B2b, an non-connection state for cutting off the connection to the second base stations B2a and B2b, and an non-transmission state for prohibiting the transmission of wireless signals to the second base stations B2a and B2b. In the embodiment, the second communication protocol may be the PHS (Personal Handy-phone System) or LTE (Long Term Evolution).

In the second communication protocol, data are transmitted and received by the second base stations B2a and B2b at predetermined frame intervals FD as shown in FIG. 5. Data in the second communication protocol includes down subframes DSF and up subframes USF. Reception of the down subframe DSF and transmission of the up subframe USF are conducted alternately.

A typical situation in which the notice signal cycle BC in the first communication protocol is an integer times the frame interval FD in the second communication protocol is now supposed. For example, the notice signal cycle BC is 100 [ms] and the frame interval FD is 5 [ms]. In other words, once timing at which the first wireless communicator 13 should receive the notice signals Aᵢ and Bᵢ and timing at which the second wireless communicator 14 should transmit a wireless signal in the up subframe USF overlap, it becomes impossible for the first wireless communicator 13 to receive the notice signals Aᵢ and Bᵢ for a long time.

In the reception state, the first wireless communicator 13 of FIG. 1 executes amplification, frequency conversion, analog-digital conversion, demodulation of baseband signal processing or the like, MAC (Media Access Control) and packet generation on wireless signals received from the first base stations B1a and B1b via the antennas 11a and 11b and the antenna switch 12. In the reception state, the second wireless communicator 14 of FIG. 1 executes amplification, frequency conversion, analog-digital conversion, demodulation, MAC and packet generation on wireless signals received from the second base stations B2a and B2b via the antennas 11a and 11b and the antenna switch 12.

In the transmission state, the first wireless communicator 13 of FIG. 1 executes MAC, modulation, digital-analog conversion, up conversion and amplification on packets to be transmitted to the first base stations B1a and B1b via the antennas 11a and 11b and the antenna switch 12. In the transmission state, the second wireless communicator 14 of FIG. 1 executes MAC, modulation, digital-analog conversion, up conversion and amplification on packets to be transmitted to the second base stations B2a and B2b via the antennas 11a and 11b and the antenna switch 12.

In the non-connection state, the first wireless communicator 13 of FIG. 1 cuts off the connections to the first base stations B1a and B1b. As a result, registration of the first wireless communicator 13 is removed from the first base stations B1a and B1b. In the non-connection state, the second wireless communicator 14 of FIG. 1 cuts off the connection to the second base stations B2a and B2b. As a result, registration of the second wireless communicator 14 is removed from the second base stations B2a and B2b.

In the non-transmission state, the second wireless communicator 14 of FIG. 1 is prohibited from transmitting wireless signals scheduled by the second base stations B2a and B2b. Incidentally, the non-transmission state may be distinguished from the reception state and the non-connection state, and may include the reception state and the non-connection state. In other words, the non-transmission state may include all the states other than the transmission state.

The network operating module 15 of FIG. 1 has a communication function of a second layer (link layer) or functions of a third layer (network layer) to a seventh layer (application layer) of an OSI (Open Systems Interconnection) reference model.

Specifically, a mobile device MT such as a notebook computer is connected to the network operating module 15. The mobile device MT has a processor configured to conduct predetermined signal processing on wireless signals transmitted and received according to the first communication protocol or the second communication protocol. In the reception state, the network operating module 15 sends packets generated by the first wireless communicator 13 or the second wireless communicator 14 to the mobile device MT. In the transmission state, the network operating module 15 generates packets based on data sent from the mobile device MT and sends the packets to the first wireless communicator 13 or the second wireless communicator 14.

Incidentally, in the embodiment, the wireless communication apparatus 10 may be incorporated in the mobile device MT integrally therewith. In that case, the antennas 11a and 11b of the wireless communication apparatus 10 are mounted so as to be embedded in the mobile device MT.

In the present embodiment, the network operating module 15 need not have all the communication functions (the first layer to the seventh layer) of all OSI reference models. For example, it is possible that the network operating module 15 has communication functions typically classified into a lower layer among the communication functions of the OSI reference model and the mobile device MT has communication functions typically classified into an upper layer among the communication functions of the OSI reference model.

The controller 16 of FIG. 1 is configured to control the antenna switch 12, the first wireless communicator 13, the second wireless communicator 14, and the network operating module 15. In particular, the controller 16 is configured to switch states of the first wireless communicator 13 and the second wireless communicator 14.

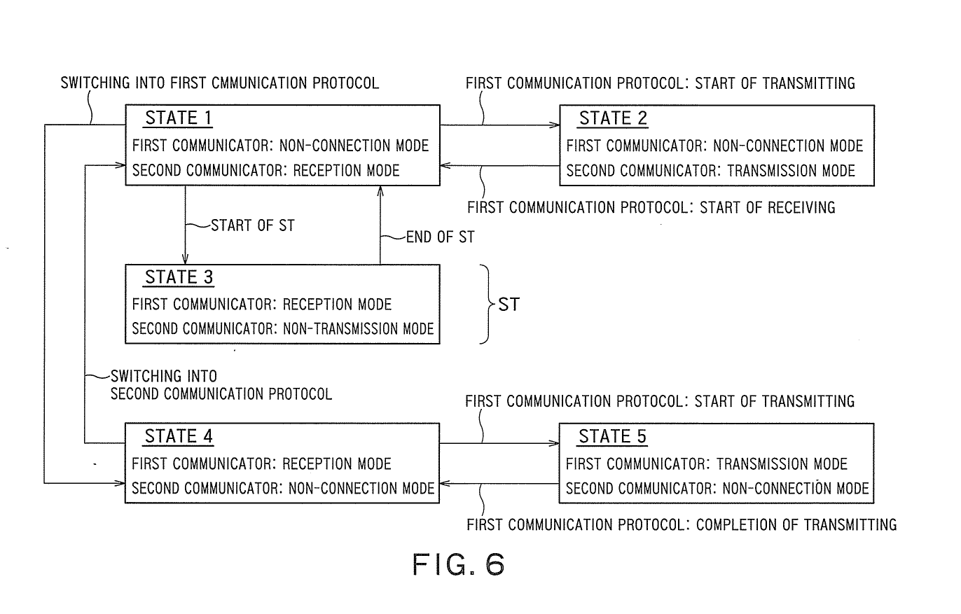

Processing conducted by the controller 16 will now be explained. FIG. 6 is a state transition diagram of the first wireless communicator 13 and the second wireless communicator 14.

The controller 16 changes states of the first wireless communicator 13 and the second wireless communicator 14. As a result, the states of the first wireless communicator 13 and the second wireless communicator 14 make transitions as shown in FIG. 6.

In a state 1 of FIG. 6, the first wireless communicator 13 is in the non-connection state and the second wireless communicator 14 is in the reception state. In the state 1, the first wireless communicator 13 is not connected to the first base stations B1a and B1b. The second wireless communicator 14 can receive wireless signals (the down subframes DSF of FIG. 5) via the antennas 11a and 11b and the antenna switch 12, generate packets based on the wireless signals, and send the packets to the network operating module 15.

In a state 2 of FIG. 6, the first wireless communicator 13 is in the non-connection state and the second wireless communicator 14 is in the transmission state. In the state 2, the first wireless communicator 13 is not connected to the first base stations B1a and B1b. The second wireless communicator 14 can receive packets from the network operating module 15, generate wireless signals based on the packets, and transmit the wireless signals (the up subframes USF of FIG. 5) to the second base stations B2a and B2b via the antennas 11a and 11b and the antenna switch 12.

In a state 3 of FIG. 6, the first wireless communicator 13 is in the reception state and the second wireless communicator 14 is in the non-transmission state. In the state 3, the first wireless communicator 13 can receive wireless signals via the antennas 11a and 11b and the antenna switch 12, generate packets based on the wireless signals, and send the packets to the network operating module 15. The second wireless communicator 14 is prohibited from transmitting wireless signals to the second base stations B2a and B2b. In other words, the controller 16 switches the second wireless communicator 14 to the non-transmission state and the first wireless communicator 13 to the reception state such that a term (hereafter referred to as “reception term”) during which the reception state is assumed includes the scan term ST.

An example of the non-transmission state will now be explained.

For example, the non-transmission state of the second wireless communicator 14 is implemented by switching of the second wireless communicator 14 to the reception state. In other words, the controller 16 switches the second wireless communicator 14 to the reception state such that a term (hereafter referred to as “non-transmission term”) during which the non-transmission state is assumed includes the scan term ST. As a result, the second wireless communicator 14 is brought into the non-transmission state. In this case, the second wireless communicator 14 receives wireless signals via the antennas 11a and 11b and the antenna switch 12, generates packets based on the wireless signals, and sends the packets to the network operating module 15. However, the second wireless communicator 14 cannot transmit wireless signals to the second base stations B2a and B2b.

The non-transmission state of the second wireless communicator 14 may be implemented by an non-transmission request to the second base stations B2a and B2b. In other words, the controller 16 sends a predetermined command to the mobile device MT to issue an non-transmission request. As a result, the second wireless communicator 14 is brought into the non-transmission state. For example, the non-transmission request is a scan request, a sleep request, or an idle request. Typical second base stations B2a and B2b are configured to permit a scan state upon receiving the scan request, permit a sleep state upon receiving the sleep request, permit an idle state upon receiving the idle request, and permit an non-transmission state upon receiving an non-transmission request. In the scan state, the wireless communication apparatus 10 temporarily interrupts connection to the second base station B2a or the second base station B2b in connection, and searches another base station (the second base station B2b or the second base station B2a). In the sleep state, the wireless communication apparatus 10 tentatively stops data transmission and reception until data to be transmitted will be generated. In the idle state, the wireless communication apparatus 10 is brought into a standby state to receive a terminal calling signal which is issued by the second base stations B2a and B2b at specific time. In the non transmission state, transmission of the wireless signals is prohibited by the second base stations B2a and B2b. That is, the wireless communication apparatus 10 does not receive any transmission permissions and transmission requests. In the non-transmission state, therefore, the wireless communication apparatus 10 cannot transmit wireless signals to the second base stations B2a and B2b.

In a state 4 of FIG. 6, the first wireless communicator 13 is in the reception state and the second wireless communicator 14 is in the non-connection state. In the state 4, the first wireless communicator 13 can receive wireless signals via the antennas 11a and 11b and the antenna switch 12, generate packets based on the wireless signals, and send the packets to the network operating module 15. The second wireless communicator 14 is not connected to the second base stations B2a and B2b.

In a state 5 of FIG. 6, the first wireless communicator 13 is in the transmission state and the second wireless communicator 14 is in the non-connection state. In the state 5, the first wireless communicator 13 can receive packets from the network operating module 15, generate wireless signals based on the packets, and transmit the wireless signals to the first base stations B1a and B1b via the antennas 11a and 11b and the antenna switch 12. The second wireless communicator 14 is not connected to the second base stations B2a and B2b.

A transition from the state 1 to the state 2 in FIG. 6 is conducted at the time when transmission in the second communication protocol starts. A transition from the state 2 to the state 1 in FIG. 6 is conducted at the time when reception in the second communication protocol starts.

A transition from the state 1 to the state 3 in FIG. 6 is conducted at the time when scan term in the first communication protocol starts. A transition from the state 3 to the state 1 in FIG. 6 is conducted at the time when scan term in the first communication protocol ends. In other words, the state 3 is maintained during the scan term ST.

A transition from the state 1 to the state 4 in FIG. 6 is conducted at the time when the first base stations B1a and B1b in the first communication protocol are found as a result of a scan in the first communication protocol conducted in the state 3, the controller 16 judges that the second communication protocol should be changed into the first communication protocol, and the first wireless communicator 13 is connected to the first base stations B1a and B1b. A transition from the state 4 to the state 1 in FIG. 6 is conducted at the time when the quality of connection to the first base stations B1a and B1b is lowered, the controller 16 judges that the first communication protocol should be changed into the second communication protocol, and the second wireless communicator 14 is connected to the second base stations B2a and B2b.

A transition from the state 4 to the state 5 in FIG. 6 is conducted at the time when transmission in the first communication protocol starts. A transition from the state 5 to the state 4 in FIG. 6 is conducted at the time when transmission in the first communication protocol ends.

Incidentally, in the embodiment, the controller 16 may switch the second wireless communicator 14 to the non-transmission state, confirms that the second wireless communicator 14 is brought into the non-transmission state, and switches the first wireless communicator 13 to the reception state. More specifically, the controller 16 generates a control signal to switch the second wireless communicator 14 to the non-transmission state. Then, the second wireless communicator 14 is brought into the non-transmission state based on the control signal generated by the controller 16, and generates a completion signal which indicates that the second wireless communicator 14 has been brought into the non-transmission state. Then, the controller 16 generates a control signal for switching the first wireless communicator 13 to the reception state.

In the embodiment, the controller 16 may switch the first wireless communicator 13 to the reception state concurrently with switching the second wireless communicator 14 to the non-transmission state.

According to the embodiment, the second wireless communicator 14 in the wireless communication apparatus 10 in which the first communication protocol for wireless LAN and the second communication protocol for TDD system coexist is brought into the non-transmission state in the scan term ST in which the first wireless communicator 13 scans the notice signals Aᵢ and Bᵢ transmitted from the first base stations B1a and B1b. According to the communication situation, therefore, the communication protocol can be switched without a time lag. In other words, for switching the communication protocol without a time lag, the wireless communication apparatus 10 needs to know correctly and quickly whether the first communication protocol can be utilized during a term in which communication is being conducted by using the second communication protocol (the state 1 or the state 2 in FIG. 6). It is possible to control to make a transition to the state 3 in FIG. 6 at a suitable time and during a suitable term by knowing that the first communication protocol can be utilized. For continuation of the communication while minimizing an obstruction to the communication caused by the second communication protocol, it is controlled such that a term (non-transmission term) over which the second wireless communicator 14 is in the non-transmission state during the scan term ST is intermittent as far as possible and short as far as possible. In addition, the first base stations B1a and B1b can be found quickly without omission by setting the scan term ST as already described. According to the communication situation, therefore, the communication protocol can be switched without a time lag.

In the embodiment, the first communication protocol is narrower in area which can be utilized than the second communication protocol, but the first communication protocol is faster than the second communication protocol. In the embodiment, therefore, it is preferable to utilize the first communication protocol preferentially if the first communication protocol can be utilized in a favorable state.

In the embodiment, the example in which the wireless communication apparatus 10 is applied to the mobile device MT has been explained. However, the scope of the present invention is not limited to this example. The present invention can be applied to any device including the wireless communication apparatus 10 such as a car navigation system, a television set having a network function, and a desktop personal computer.

In the embodiment, Equation 1 is true of the scan term ST of the first wireless communicator 13 and scan terms ST are arranged in the residue series to overlap in parts. In addition, the scan term ST in the first wireless communicator 13 is at least the residue when the notice signal cycle BC is a dividend and the first cycle C1 is a divisor. Even if the scan conducted by the first wireless communicator 13 is intermittent, therefore, the notice signals Aᵢ and Bᵢ transmitted respectively from the first base stations B1a and B1b can be detected without omission.

In the embodiment, the reception channels CH2 to CH6 are switched every second cycle C2. Even if the transmission channels of the first base stations B1a and B1b are unknown, therefore, the notice signals Aᵢ and Bᵢ can be detected without omission.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wireless communication apparatus comprising:
a first wireless communicator configured to transmit and receive a wireless signal according to a first communication protocol, and scan a notice signal during a predetermined scan term in a first cycle non-integer times at least one of notice signal cycles in the first communication protocol,
a second wireless communicator configured to transmit and receive the wireless signal according to a second communication protocol; and
a controller configured to switch the second wireless communicator to an non-transmission state and the first wireless communicator to a reception state during the scan term.

2. The apparatus of claim 1, wherein a part of the scan term overlaps a part of an adjacent scan term adjacent to the scan term in a residue series in the case where the first cycle is a dividend and the notice signal cycle is a divisor.

3. The apparatus of claim 1, wherein the scan term is at least a quotient in the case where the notice signal cycle is a dividend and a predetermined coefficient is a divisor.

4. The apparatus of claim 2, wherein the scan term is at least a quotient in the case where the notice signal cycle is a dividend and a predetermined coefficient is a divisor.

5. The apparatus of claim 3, wherein the first wireless communicator successively scans the notice signal during the scan term which is at least a residue in the case where the notice signal cycle is a divisor and the first cycle is a dividend.

6. The apparatus of claim 4, wherein the first wireless communicator successively scans the notice signal during the scan term which is at least a residue in the case where the notice signal cycle is a divisor and the first cycle is a dividend.

7. The apparatus of claim 1, wherein the controller switches reception channels of the first wireless communicator in a second cycle which is at least a cyclical cycle when the first wireless communicator is switched to the reception state, the cyclical cycle which is least common multiple of the notice signal cycle and the first cycle.

8. The apparatus of claim 2, wherein the controller switches reception channels of the first wireless communicator in a second cycle which is at least a cyclical cycle when the first wireless communicator is switched to the reception state, the cyclical cycle which is least common multiple of the notice signal cycle and the first cycle.

9. The apparatus of claim 3, wherein the controller switches reception channels of the first wireless communicator in a second cycle which is at least a cyclical cycle when the first wireless communicator is switched to the reception state, the cyclical cycle which is least common multiple of the notice signal cycle and the first cycle.

10. The apparatus of claim 4, wherein the controller switches reception channels of the first wireless communicator in a second cycle which is at least a cyclical cycle when the first wireless communicator is switched to the reception state, the cyclical cycle which is least common multiple of the notice signal cycle and the first cycle.

11. The apparatus of claim 5, wherein the controller switches reception channels of the first wireless communicator in a second cycle which is at least a cyclical cycle when the first wireless communicator is switched to the reception state, the cyclical cycle which is least common multiple of the notice signal cycle and the first cycle.

12. The apparatus of claim 6, wherein the controller switches reception channels of the first wireless communicator in a second cycle which is at least a cyclical cycle when the first wireless communicator is switched to the reception state, the cyclical cycle which is least common multiple of the notice signal cycle and the first cycle.

13. The apparatus of claim 1, wherein the controller switches the second wireless communicator to the non-transmission state, confirms that the second wireless communicator is brought into the non-transmission state, and switches the first wireless communicator to the reception state.

14. The apparatus of claim 1, wherein the controller switches the first wireless communicator to the reception state concurrently with switching the second wireless communicator to the non-transmission state.

15. The apparatus of claim 1, wherein the controller switches the second wireless communicator to the reception state in such a manner that a reception term comprises the scan term.

16. The apparatus of claim 1, wherein the controller issues an non-transmission request in such a manner that an non-transmission term comprises the scan term.

17. The apparatus of claim 1, wherein the scan term is set in such a manner that length of overlapping parts of adjacent scan terms is longer than length of continuation time for which the notice signal are transmitted.

18. The apparatus of claim 1, wherein the controller preferentially selects the first wireless communicator when both of the first wireless communicator and the second wireless communicator are available.

19. The apparatus of claim 1, wherein the first wireless communicator selectively executes a first scan operation to scan the notice signal in the first cycle non-integer times a predetermined first notice signal cycle and a second scan operation to scan the notice signal in the first cycle non-integer times a second notice signal cycle different from the first notice signal cycle.

20. The apparatus of claim 1, wherein at least a portion of the apparatus is composed of a semiconductor integrated circuit.
